(19) United States
(12) Patent Application Publication
(10) Pub. No.: US 2026/0215614 A1
(43) Pub. Date: Jul. 30, 2026

(54) VARIABLE PRESSURE OUTLET FOR BEVERAGE MACHINE

(71) Applicant: Keurig Green Mountain, Inc., Burlington, MA (US)

(72) Inventors: Jonathan Meehan, Chicago, IL (US); Blair Mikkelsen, Chicago, IL (US); Janelle Marie Gregory, Chicago, IL (US); Nicholas John Raleigh, Saint Joseph, MI (US)

(73) Assignee: Keurig Green Mountain, Inc., Burlington, MA (US)

(21) Appl. No.: 19/143,975

(22) PCT Filed: Dec. 27, 2023
(86) PCT No.: PCT/US2023/085958

§ 371 Date: Jun. 27, 2025

Related U.S. Application Data
(60) Provisional application No. 63/435,756, filed on Dec. 28, 2022.

(51) Int. Cl. A47J 31/46; F15B 13/042; F16K 17/04

(52) U.S. Cl. CPC A47J 31/461; F15B 13/042; F16K 17/0486

(57) ABSTRACT

An outlet valve for use with a beverage machine may be controllable to provide one or more levels of backpressure at the outlet of the beverage machine. The valve may include a shuttle movable relative to a port and having a plunger that is resiliently biased to move relative to the shuttle. The shuttle may be configured to adjust a backpressure on fluid in a flowpath based on a position of the shuttle relative to the port.

### CROSS-REFERENCE TO RELATED APPLICATION

This application claims the benefit of U.S. Provisional Application No. 63/435,756, filed Dec. 28, 2022, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Pat. No. 8,094,998 and US Patent application publication 2017/0307252 disclose systems in which water in a heater tank is forced to flow out of the tank and to a beverage making station or dispensing location by introducing unheated water into the tank. U.S. Pat. No. 6,382,083 describes a coffee machine with a user adjustable valve between a brew chamber and beverage outlet that allows a user to influence the amount of coffee brewed per unit time. U.S. Pat. No. 8,991,304 describes a coffee machine with a spring-loaded pressure valve arranged between the brewing chamber and the beverage outlet.

### SUMMARY OF INVENTION

Aspects of the disclosure relate to a valve that can be used in conjunction with a beverage machine outlet. In some cases, the valve can be adjustable, e.g., infinitely adjustable, to provide varying levels of backpressure to create crema or foam in a coffee beverage. This can allow a user to provide a desired backpressure level, or little or no backpressure at all, in a simple and effective way.

In some embodiments, a valve for use with a beverage machine outlet includes a valve body having an inlet, an outlet, a flowpath between the inlet and the outlet, and a port in the flowpath. As an example, the inlet of the valve body may be configured to fluidly connect to an outlet of a brew chamber or other part of a beverage machine from which beverage is produced. In some cases, the valve body can be formed integrally, e.g., as a unitary part, with a brew chamber; in some cases, the valve body can be connected to a brew chamber by a tube or other conduit. The outlet of the valve body may be fluidly coupled to or act as a beverage outlet of a beverage machine, e.g., a port from which beverage is dispensed into a user's cup. The valve can include a shuttle movable relative to the valve body, e.g., in a cavity of the valve body, and including a plunger that is resiliently biased to move relative to the shuttle or an actuator that moves the shuttle. In some cases, the shuttle may be configured to adjust a backpressure on fluid in the flowpath based on a position of the shuttle relative to the valve body. For example, the shuttle can be configured for movement toward and away from the port to put the plunger into and/or out of contact with the port. In some examples, the shuttle can be configured for movement to put the shuttle into and/or out of fluid communication with the port. The plunger may be movable relative to the shuttle or an actuator that moves the shuttle, e.g., so that movement of the shuttle influences a position of and/or bias on the plunger relative to the port. In some cases, movement of the shuttle can cause a resilient force on the plunger that biases the plunger into contact with a valve seat to be adjusted, e.g., based on the position of the shuttle. For example, a spring may be provided between the shuttle and the plunger and configured to resiliently bias the plunger toward the port. Movement of the shuttle relative to the port can adjust a resilient biasing force on the plunger that urges the plunger into contact with the port. In some cases, movement of the shuttle can influence an extent to which fluid exiting the port flows through a valve seat of the shuttle, e.g., a position of the shuttle can adjust an extent to which flow through the port enters a flowpath or channel of the shuttle that includes the valve seat. The plunger can be resiliently biased to contact the valve seat and provide a resistance to flow through the valve seat.

In some embodiments, the shuttle can include a conduit or chamber having an inlet at an inlet end and an outlet, and the plunger may be positioned at the inlet end of the shuttle. For example, the shuttle can include a bore at the inlet end in which or relative to which the plunger is movable. A spring may be positioned in the chamber and configured to resiliently bias the plunger to move out of the bore, e.g., the plunger may be partially positioned in the bore and the spring may urge the plunger to move out of the bore. The plunger may have a leading end or other portion that extends from the inlet end of the shuttle, e.g., so that the leading end can contact the port when the shuttle is suitably positioned relative to the port. In some cases, the inlet end can have a valve seat, e.g., that includes a bore through which flow can enter the chamber of the shuttle from the port. The plunger can be resiliently biased to contact the valve seat, e.g., to resist flow from the port through the valve seat and into the chamber. In some cases, the bore and the plunger may be configured to permit fluid flow past the plunger and through the chamber from the inlet to the outlet of the chamber. For example, fluid may flow around the plunger in a gap or other space between the plunger and the shuttle chamber when flowing from the chamber inlet toward the chamber outlet. Flow through the shuttle chamber may pass through a restriction or other part of the shuttle, e.g., which is configured to produce foam or have other effect on the beverage, and/or flow may be around the shuttle toward the outlet of the valve. For example, the shuttle may include a flow restrictor downstream of the plunger configured to produce foam or have other effect in addition to any effect the plunger has on such flow.

In some cases, the shuttle may have a portion that is sealingly engaged with the valve body, e.g., to influence flow through or otherwise past the shuttle and/or to an alternate flow path depending on a position of the shuttle relative to the valve body. For example, the shuttle may have a conduit or chamber that is sealingly engaged with the valve body in the cavity such that fluid flow out of the port passes through the chamber from the valve inlet to the valve outlet or bypasses the chamber and flows directly from the valve inlet to the valve outlet. In some cases, the valve body may include or otherwise be coupled with a bypass channel fluidly coupled to the flowpath between the inlet and the outlet of the valve and downstream of the port. The shuttle may be configured for movement to permit fluid flow from the port to the bypass channel or to otherwise bypass a chamber of the shuttle, e.g., for positions of the shuttle relatively distant from the port, flow from the port may pass to the cavity and to the valve outlet.

However, for positions of the shuttle relatively near the port, flow may be prevented from bypassing the chamber and may instead pass to or through the shuttle chamber at least in part. For example, the shuttle may include a conduit extending from an inlet end to an outlet end, and the conduit may be configured for fluid flow along the flowpath through the conduit from the inlet end to the outlet end. The shuttle may be movable between a first position in which flow through the port passes through the conduit from the inlet end to the outlet end, and a second position in which flow through the port passes to the bypass channel. In some cases, with the shuttle in the first position the plunger may be resiliently biased into contact with the port, and with the shuttle in the second position the plunger may be out of contact with the port. In some embodiments, the shuttle may be configured so that when in a first position, flow through the port enters a chamber of the shuttle, e.g., through a valve port on the shuttle, and passes through the chamber to the valve outlet. The plunger may resist flow through the valve seat, such as by contacting the valve seat with a resilient force. When in a second position, flow through the port may bypass the chamber and instead flow through a portion of the cavity in which the shuttle is located to the valve outlet. The shuttle may be configured to permit flow around an outer surface of the shuttle and through the cavity to the valve outlet.

In some embodiments, the shuttle may be movable by a user relative to the valve body to adjust the backpressure on fluid in the flowpath. For example, the valve body and shuttle may be configured to adjust an amount of crema or foam produced by the valve in coffee flowing through the valve based on a position of the shuttle relative to the valve body. The shuttle may be movable from a first position relative to the valve body to permit unrestricted flow through the port, e.g., so that no crema or foam is produced in a coffee beverage, to a second position in which the plunger and port or other valve seat cooperate to produce crema or foam in the beverage. In some cases, the shuttle may be movable between two or more defined positions to provide different levels of backpressure. In some cases, the shuttle may be movable between multiple undefined positions such that the shuttle is infinitely adjustable relative to the valve body, e.g., to provide an infinite number of backpressure settings for the valve. For at least some positions, flow through the port may pass through a chamber of the shuttle and for at least some positions may bypass the chamber of the shuttle.

In some embodiments, a valve for use with a beverage machine outlet includes a valve body having an inlet, an outlet, a cavity, a port and a flowpath from the inlet to the outlet that includes at least a portion of the cavity and the port. The cavity may be downstream of the port and have a larger cross-sectional area than the port. A shuttle may be movable in the cavity relative to the port and include a plunger that is resiliently biased to move relative to the shuttle and/or an actuator of the shuttle, e.g., to move toward the port and/or toward an inlet end of the shuttle. In some cases, a spring between the shuttle and the plunger may be configured to resiliently bias the plunger toward the port. The shuttle may be configured to adjust a backpressure on fluid in the flowpath based on a position of the shuttle relative to the valve body and/or the port. For example, in some cases the shuttle may be movable between a first position in which the shuttle is in contact with the port, and a second position in which the shuttle is out of contact with the port. In some cases the shuttle may be movable between a first position in which the shuttle is in fluid communication with the port, and a second position in which the shuttle is out of fluid communication with the port. In some embodiments, the plunger may be configured to contact the port to resist flow through the port. In some cases, the shuttle may be configured so flow through the port enters a chamber of the shuttle for at least some positions of the shuttle relative to the valve body. For example, the shuttle may be configured to sealingly engage with a portion of the valve body at the port in the first position, e.g., so that flow through the port is forced to flow into a chamber of the shuttle. The shuttle may include a chamber in which the plunger is positioned and the chamber and the plunger may be configured to permit fluid flow past the plunger and into the chamber. The shuttle may have an outlet such that fluid entering the shuttle chamber exits the shuttle outlet and passes to the cavity and/or the valve outlet. In some cases, the shuttle may be sealingly engaged with the valve body in the cavity, e.g., so the shuttle can maintain sealing engagement through a range of motion relative to the valve body. The shuttle may be movable by a user relative to the valve body to adjust the backpressure on fluid in the flowpath, e.g., manually and/or by automated control.

In some embodiments, the shuttle may be movable between a first position in which flow through the port is forced to flow along a first path into a chamber of the shuttle and past the plunger, and a second position in which flow through the port is along a second path that bypasses the chamber. The chamber may be in fluid communication with the port when the shuttle is in the first position and is out of fluid communication with the port when the shuttle is in the second position. For example, the shuttle may include a valve seat against which the plunger is biased to engage and flow from the port along the first path passes through the valve seat and into the chamber. In some cases, a spring between the shuttle and the plunger may be configured to resiliently bias the plunger toward the valve seat, e.g., so the plunger provides a resistance to flow through the valve seat.

In some embodiments, the shuttle may be movable between first and second positions relative to the valve body and a resistance to flow along the flowpath is higher with the shuttle in the first position than a resistance to flow along the flowpath with the shuttle in the second position.

In some embodiments, the shuttle includes a chamber having a shuttle inlet at an inlet end and a shuttle outlet. The plunger may be positioned at the inlet end of the shuttle, e.g., so the plunger is movable in the chamber. A spring may be positioned in the chamber and configured to resiliently bias the plunger toward the inlet end of the chamber. In some cases, the shuttle includes a valve seat that defines the shuttle inlet and the plunger is biased to move into contact with the valve seat. The shuttle may be movable in the cavity between a first position in which flow through the port passes through the chamber to the outlet, and a second position in which flow through the port bypasses the chamber and passes through the cavity to the outlet.

In some embodiments the valve may be combined with a beverage machine including a liquid supply arranged to provide a liquid for forming a beverage. A liquid supply may include any suitable number and/or type of components, such as a mains water connection, a cold water reservoir, pump(s), diverter valve(s), a liquid conditioner (such as a chiller, heater, carbonator, etc.), and so on. The machine may include a brew chamber arranged to mix the liquid with a beverage material to form a beverage, e.g., beverage material may be provided to the brew chamber in a cartridge, in loose form or any suitable arrangement for mixing with a liquid such as water. In some embodiments, the cartridge may be provided in the form of a beverage tablet. The valve may be fluidly coupled to an outlet of the brew chamber and be configured to adjust a pressure in the brew chamber and/or other portions of a flow path of the machine based on the position of the shuttle relative to the valve body. In some cases, the outlet of the valve body may be fluidly coupled to a beverage outlet of the beverage machine for dispensing the beverage. In some embodiments, such as where the machine is configured to form a coffee beverage, the valve may be configured to adjust an amount of crema or foam dispensed with a coffee beverage from the beverage outlet.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a front, left side perspective view of a beverage forming system in an illustrative embodiment;

FIG. 2 is a right side view of the beverage forming system in FIG. 1;

FIG. 3 shows a schematic diagram of functional components of the beverage forming system in an illustrative embodiment;

FIG. 4 shows a cross sectional view of a beverage outlet valve in an illustrative embodiment;

FIG. 5 shows a cross sectional view of the FIG. 4 valve with the shuttle positioned to permit flow to a bypass channel;

FIG. 6 shows a perspective view of the FIG. 4 valve including a handle configured for movement of the shuttle;

FIG. 7 shows a front, right side perspective view of a beverage outlet valve having an actuator in an illustrative embodiment;

FIG. 8 is a rear, left side perspective view of the FIG. 7 valve;

FIG. 9 is a cross sectional view of the FIG. 7 valve along the line 9-9 with the shuttle in a first position;

FIG. 10 is a perspective view of the shuttle and actuator of the FIG. 7 valve;

FIG. 11 is a cross sectional view of the FIG. 7 valve along the line 9-9 with the shuttle in a second position; and

FIG. 12 is a cross sectional schematic view of a beverage outlet valve in another illustrative embodiment.

### DETAILED DESCRIPTION

It should be understood that aspects of the disclosure are described herein with reference to certain illustrative embodiments and the figures. The illustrative embodiments described herein are not necessarily intended to show all aspects of the disclosure, but rather are used to describe a few illustrative embodiments. Thus, aspects of the disclosure are not intended to be construed narrowly in view of the illustrative embodiments. In addition, it should be understood that aspects of the disclosure may be used alone or in any suitable combination with other aspects of the invention. For example, a beverage outlet valve is described that in some embodiments includes a shuttle that is movable to provide two or more backpressure levels and that includes a bypass channel. However, these features need not necessarily be used together. An outlet valve may be provided with a shuttle that provides only two levels of backpressure along with a bypass channel, or an outlet valve may be provided with a shuttle that provides three or more levels of backpressure and without a bypass channel. Similarly, embodiments are described in which a plunger is movable relative to a shuttle and in which the shuttle is movable by hand to provide different backpressure levels. Again, these features may be used together or independently, e.g., a valve including a manually movable shuttle need not necessarily include a plunger that is movable relative to the shuttle, but instead the plunger may be fixed relative to the shuttle. Likewise, a shuttle with a movable plunger need not be manually adjustable in position. In short, features of embodiments described herein can be used together, or not, in any suitable combination at least to the extent not mutually exclusive.

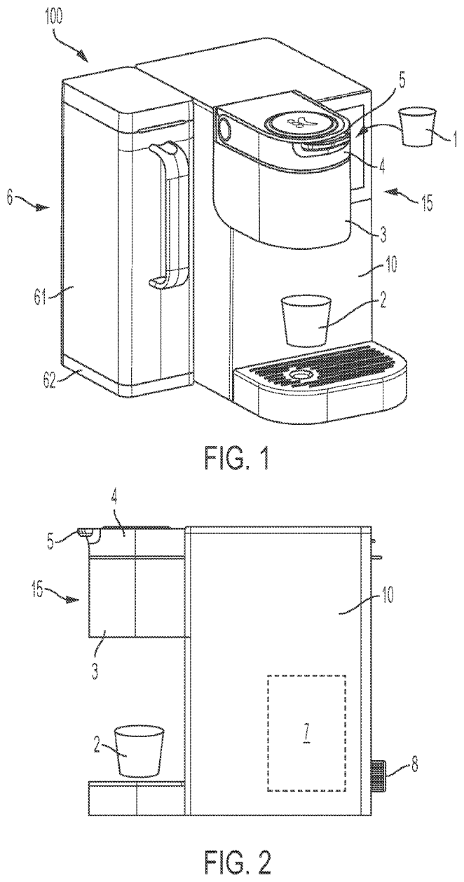

FIG. 1 shows a perspective view of a beverage forming system 100, e.g., a beverage machine, that incorporates various features of the disclosure. Although the beverage forming system 100 may be used to form any suitable beverage, such as tea, coffee, other infusion-type beverages, beverages formed from a liquid or powdered concentrate, soups, juices or other beverages made from dried materials, carbonated or uncarbonated beverages, or other, in this illustrative embodiment the system 100 is arranged to form coffee beverages. In some embodiments, a beverage cartridge 1 may be provided to the system 100 and used to form a beverage that is dispensed into a user's cup or other suitable container 2. The cartridge 1 may be manually or automatically placed in a brew chamber 15 that can include a cartridge holder 3 and cover 4. For example, the cartridge holder 3 may include a cup-shaped or otherwise suitably shaped opening in which the cartridge 1 may be placed. With a cartridge 1 placed in the cartridge holder 3, a handle 5 may be moved (e.g., downwardly) so as to move the cover 4 to a closed position (as shown in FIG. 1). In the closed position, the cover 4 may at least partially cover the cartridge 1, e.g., so the cartridge is at least partially enclosed in the brew chamber 15. Water or other liquid may be provided to the cartridge 1 (e.g., by injecting the liquid into the cartridge interior) to form a beverage that exits the cartridge 1 and is provided via a beverage outlet to a cup 2 or other container. As can be seen in FIGS. 1 and 2 for example, liquid may be provided to a brew chamber 15 or other dispensing station from an external reservoir 6 and/or an internal reservoir 7. The reservoirs 6, 7 may be provided with liquid from a mains water connection 8 which allows the machine 100 to be connected to a plumbed water source and/or by a user, e.g., by pouring the liquid into the external reservoir 6 and/or through an opening in the beverage machine housing 10 into the internal reservoir 7. In some embodiments, the external reservoir 6 can include a tank 61 which is removable from a tank base 62, e.g., to allow the tank 61 to be more easily filled with water. The tank base 62 may additionally be removable from the housing 10 if the external reservoir 6 is not used.

The system 100 shown in FIGS. 1 and 2 is only one example of a beverage forming system that can incorporate inventive features described herein. Thus, inventive features may be employed with any suitably arranged system 100, including drip-type coffee brewers, espresso-type coffee machines, carbonated beverage machines, and other systems that dispense a beverage. Such systems need not necessarily use a cartridge 1, but instead the brew chamber or other dispensing station may accept ground coffee (e.g., in loose, compressed or pellet form) or other beverage material in other ways to make a beverage. Also, the brew chamber 15 need not necessarily include a cartridge holder 3 and a cover 4. For example, the brew chamber may include a filter basket or other receptacle arranged to receive beverage material and to combine the beverage material with water or other liquid to form a beverage. In some embodiments, the brew chamber need not be user accessible, but instead beverage material may be automatically provided to, and/or removed from, the brew chamber. Moreover, the system 100 need not have a brew chamber 15, but instead other types of dispensing stations, e.g., that dispense hot and/or cold water or other liquid (whether still or carbonated) at a beverage outlet such as a dispensing nozzle without mixing with any beverage ingredient. Accordingly, a wide variety of different types and configurations of beverage forming systems may be employed with inventive features.

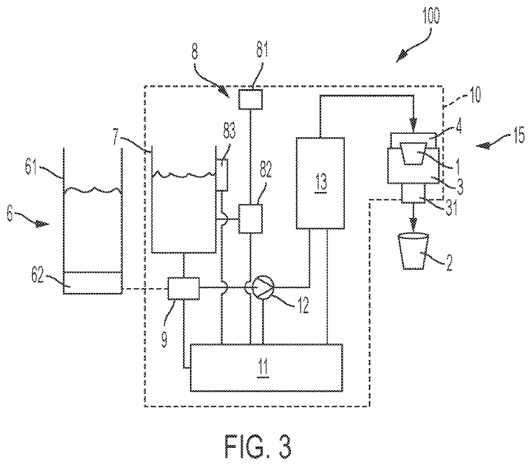

FIG. 3 shows a schematic diagram of a liquid supply and other components of an illustrative beverage machine 100 for forming a beverage. As noted above, the liquid supply of the machine 100 may include an external reservoir 6 and/or an internal reservoir 7, e.g., including a mains water connection 8 having a connector 81 to fluidly connect to mains water, a mains valve 82 that controls flow to the internal reservoir 7 and a level sensor 83 to detect a liquid level in the internal reservoir 7. The mains valve 82 can be controlled by a controller or control circuitry 11 based on information from the liquid level sensor 83, e.g., the mains valve 82 can be operated to establish a desired water level in the internal reservoir 7. A distribution valve 9 can selectively couple either of the reservoirs 6, 7 to the brew chamber 15 or other dispensing station for delivery of liquid. The distribution valve 9 may be controllable, such as manually by a user or electronically by the controller 11, to select between the external reservoir 6 and internal reservoir 7. Beverage parameters may be set by default by the controller 11, by a user interacting with a user interface, and/or by reading a machine readable feature on a cartridge 1 and using corresponding parameters.

A pump 12 may deliver liquid from the valve 9 to a heater tank 13 or other liquid conditioning device, e.g., to heat, cool, carbonate, or otherwise condition water or other liquid for forming a beverage. Employing a pump 12 may allow the machine 100 to vary a flow rate and/or pressure of the liquid as desired, e.g., to form espresso-type or other beverages using higher pressure liquid as well as drip-type coffee or other beverages made using lower pressure liquid. In some embodiments, pumping of water or other liquid into the heater tank 13 causes heated liquid to flow to the brew chamber 15 for mixing with a beverage medium (or not) and for dispensing as a beverage.

In some embodiments, an outlet valve 31 may be fluidly coupled to an outlet of the brew chamber 15 or other dispensing station and may be used to control a pressure in the brew chamber 15 or other portion of the beverage flow path. For example, when forming a coffee beverage, the valve 31 may be operated to adjust a backpressure in the brew chamber 15 or elsewhere in the flow path to cause (or prevent) formation of crema or other foam in the coffee beverage. The valve 31 may perform other functions, such as controlling a flow rate of liquid through the brew chamber 15, selecting a beverage outlet from which beverage is dispensed, etc. The valve 31 may be manually controlled, e.g., by a user moving a handle, lever or other component, and/or automatically, e.g., by an electric or other actuator under the control of the control circuit 11 to move one or more components of the valve 31.

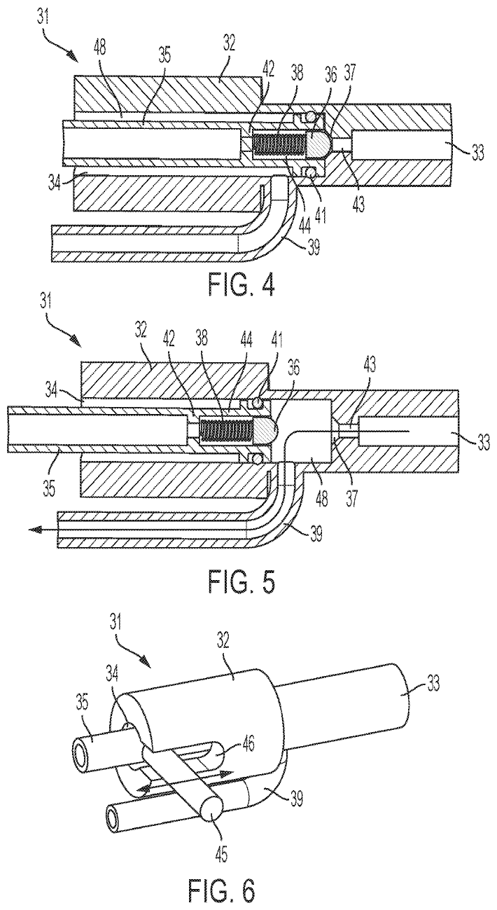

In some embodiments, the outlet valve may include a valve body having an inlet, an outlet, a flowpath between the inlet and the outlet, and a port in the flowpath. For example, FIG. 4 shows a cross sectional view of an outlet valve 31 that includes a valve body 32 having an inlet 33, an outlet 34, and a flowpath extending between the inlet 33 and the outlet 34. A port 37 may be positioned in the flowpath downstream of the inlet 33 and upstream of the outlet 34. The inlet 33 may be configured for coupling to an outlet of a brew chamber, e.g., by coupling an outlet conduit or port of the brew chamber outlet to the inlet 33, forming the valve body 32 as a unitary part of a portion of the brew chamber 15, etc. The outlet 34 may be configured for coupling to a dispensing outlet of a beverage machine, e.g., by connecting the outlet 34 to a conduit or other component that is fluidly connected to the dispensing outlet, and/or may be configured to operate as a dispensing outlet of the beverage machine, e.g., so beverage is dispensed direction from the outlet 34 to a cup 2 or other receptacle. The port 37 may be configured in different ways, e.g., as a structure including a frustoconical, flat, or otherwise shaped surface for interacting with a valve gate or other component to control flow through the port 37. In some embodiments, the port 37 need not have any structure or configuration to interact with a valve gate. In some cases, the port 37 may include a restriction 43 or other flowpath portion that has a reduced cross-sectional area as compared to portions of the flowpath immediately upstream and/or downstream of the restriction 43.

The valve 31 may include a shuttle 35 that is movable relative to the valve body 32 and/or the port 37 and that includes a plunger 36 or other valve gate that is configured to interact with the port 37 or other component to influence flow through the port 37, e.g., to influence flow through the valve 31 in a direction from the inlet 33 to the outlet 34. As an example, the plunger 36 can include a valve gate element with a partial spherical surface, frusto-conical or conical surface, flat surface, or other surface that can interact with the port 37 or other valve seat to restrict or otherwise resist flow through the port 37. In some cases, the plunger 36 can be movable relative to the shuttle 35, e.g., resiliently biased to move toward the port 37 by a spring 38 or other resilient element. In some embodiments, the resilient force of the spring 38 may bias the plunger 36 into contact with the port 37 or other valve seat (such as a valve seat on the shuttle), e.g., to provide a resistance to flow through the port 37. As an example, the plunger 36 can be biased into contact with the port 37 such that a pressure upstream of the port 37 must exceed a threshold for flow through the port 37 to occur. For pressures lower than the threshold, the plunger 36 and port 37 or other valve seat may prevent flow or permit a relatively reduced flow through the port 37. In some cases, the plunger 36 and port 37 or other valve seat may be configured to adjust a backpressure on fluid in the flowpath, e.g., upstream of the port 37. As an example, interaction of the plunger 36 and port 37 may create backpressure in a brew chamber 15 to cause crema or other foam to be generated during coffee beverage formation. A spring constant or other feature of the spring 38 and/or a position of the shuttle 35 relative to the valve body 32 may be configured to provide a desired backpressure or other resistance to flow.

In some cases, the shuttle 35 may be configured to adjust a backpressure of fluid in the flowpath, e.g., upstream of the port 37, based on a position of the shuttle 35 relative to the valve body 32 and/or the port 37. For example, the shuttle 35 can be movable relative to the valve body 32 between a first position in which the plunger 36 is resiliently biased into contact with the port 37, e.g., as shown in FIG. 4, and a second position in which the plunger 36 is out of contact with the port 37 or otherwise is positioned to permit flow through the port 37 in an unrestricted way, e.g., as shown in FIG. 5. In some cases, the shuttle 35 can be configured to permit flow past the plunger 36 and through or otherwise past the shuttle 35, and such flow may occur whether the shuttle 35 is in the first position and/or the second position. For example, in some cases, the shuttle 35 may include a chamber, such as a conduit extending from an inlet end where the plunger 36 is positioned to an outlet end, and the plunger 36 and shuttle 35 may be configured so that fluid exiting the port 37 can flow past the plunger 36 and through the shuttle chamber from the inlet end to the outlet end. This can be seen in FIG. 4, for example, where fluid that flows through the port 37 can flow past the plunger 36 (e.g., via a gap between the plunger 36 and the shuttle 35) and through the shuttle 35 toward the outlet 34. Such flow can also occur through or otherwise past the shuttle 35 when the shuttle 35 is positioned where the plunger 36 is out of contact with the port 37, e.g., as shown in FIG. 5. In some cases, the shuttle 35 can include a seal 41, e.g., an o-ring, that sealingly engages the shuttle 35 with the valve body 32 and maintains a sealing engagement through a range of movement of the shuttle 35 relative to the valve body 32. Such an arrangement may force or otherwise direct flow along the pathway from the inlet 33 to the outlet 34 to pass through the shuttle 35, e.g., a flow path through a conduit or chamber of the shuttle 35, or not. However, in some cases, the shuttle 35 need not be sealingly engaged with the valve body 32, and fluid may flow past the shuttle 35 between an outer surface of the shuttle 35 and the valve body 32, e.g., in one or more gaps between the shuttle 35 and valve body 32. For example, in some cases the shuttle 35 exterior surface may include one or more grooves or flow channels that permit fluid flow between the shuttle 35 and a cavity 48 of the valve body 32 in which the shuttle 35 is positioned. Thus, flow need not necessarily pass through the shuttle 35, but may pass around the shuttle 35, at least for some positions of the shuttle 35 relative to the valve body 32.

In some embodiments, the valve body 32 can include a bypass channel 39 fluidly coupled to the flowpath between the inlet 33 and the outlet 34 of the valve body 32 and downstream of the port 37, e.g., as can be seen in FIG. 5. For example, the bypass channel 39 can be fluidly coupled to a cavity 48 of the valve body 32 in which the shuttle 35 is movable. In some cases, the shuttle 35 may be configured for movement to permit fluid flow from the port 37 to the bypass channel 39. In some cases, the bypass channel 39 may provide a flowpath with less resistance to flow than that provided by the shuttle 35 through the valve body 32 and to the outlet 34. Thus, all or most fluid flowing through the port 37 may pass through the bypass channel 39, e.g., with the shuttle 35 positioned so the plunger 36 is out of contact with the port 37 as shown in FIG. 5. As a result, the shuttle 35 may be movable to a first position such as that shown in FIG. 4 to provide at least some resistance to flow through the port 37, e.g., to establish a desired backpressure in a brew chamber 15. Any flow that is permitted through the port 37 may flow through or otherwise past the shuttle 35 and to the outlet 34, e.g., because the seal 41 may prevent flow in a space between the shuttle 35 and valve body 32 and therefore prevent flow to the bypass channel 39. Alternately, the shuttle 39 need not be sealingly engaged with the valve body 32 and may have a chamber of the shuttle 35 fluidly coupled to the port so flow through the port 37 enters the chamber where the plunger 36 is located. The shuttle 35 may also be movable to a second position, e.g., as shown in FIG. 5, so that the shuttle 35 does not resist flow through the port 37 and any flow through the port 37 passes to the bypass channel 39. Although the bypass channel 39 is shown as having an outlet end that is separate from the outlet 34 of the valve body 32, this is not required. For example, the outlet end of the bypass channel 39 may be connected to the flowpath through the valve body 32 at a location upstream of the outlet 34 so that fluid flow through the bypass channel 39 exits through the outlet 34. As will be appreciated, the bypass channel 39 need not be a structure that extends from the valve body 32, but may instead include a groove or other flow channel provided in a portion of the valve body 32, e.g., that extends along a length of the valve body cavity in which the shuttle 35 is located. As an example, one or more grooves may be formed in the wall of the cavity of the valve body 32 where the shuttle 35 is located and/or along the shuttle 35, and the grooves may extend along the direction of flow from the inlet 33 toward the outlet 34. The shuttle 35 may be movable so that the seal 41 can block off or prevent flow through such a groove or channel when the shuttle 35 is in the first position, e.g., of FIG. 4, and permit flow into the groove or channel when the shuttle 35 is in the second position, e.g., like that in FIG. 5.

In some cases, the shuttle 35 can be movable to adjust an amount that the shuttle 35 resists flow through the port 37. In some cases, movement of the shuttle 35 can adjust an amount that the plunger 36 resists flow through the port 37 to be one or more levels between a maximum resistance and a minimum resistance to flow. Thus, the shuttle 35 can be configured to provide three or more levels of backpressure or other resistance to flow through the valve 31 based on the position of the shuttle 35, e.g., a maximum resistance, zero resistance, and one or more intermediate resistance levels between the maximum resistance and minimum resistance. As noted above, the plunger 36 can be biased into contact with the port 37 or other valve seat by a spring 38 or other resilient element. With the shuttle 35 moved to a position in which the shuttle 35 is as close as possible to the port 37, e.g., as shown in FIG. 4, the spring force on the plunger 36 may be at a maximum such that the plunger 36 provides a maximum resistance to flow through the port 37. This may permit the valve 31 to generate a maximum backpressure upstream of the valve 31. However, if the shuttle 35 is moved away from the port 37 and so that the plunger 36 remains in contact with, or at least is biased by the spring 38 so the plunger 36 would be in contact with the port 37 absent any flow through the valve 31, the resilient force of the spring 38 on the plunger 36 urging the plunger 37 into contact with the port 37 will be at a reduced level. As a result, the plunger 36 will provide an intermediate level of resistance to flow through the port 37 that is between a maximum level and minimum resistance (e.g., where the plunger 36 is out of contact with the port 37 and cannot contact the port 37 even in the absence of flow through the valve 31). As will be appreciated, the shuttle 35 can be movable relative to the port 37 so as to provide an infinitely adjustable backpressure level between a maximum value and a zero or minimum value.

In some cases, the shuttle 35, plunger 36 and/or port 37 may be configured to provide multiple levels of resistance to flow through the port 37. For example, the shuttle 35 may include a bore or chamber 44 at the inlet end in which the plunger 36 is movable. A spring 38 may be located in the chamber 44 and configured to bias the plunger 36 to move away from the shuttle 35. For example, a downstream end or end of the spring 38 farthest from the port 37 may engage with a ledge 42 that is fixed to the shuttle 35. For example, the ledge 42 may include an annular portion that extends inwardly from an inner wall of the shuttle 35. The ledge 42 may include one or more openings to provide fluid flow past the ledge 42, e.g., to permit flow through the shuttle 35 from its inlet end to its outlet end. An upstream end or end of the spring 38 nearest the port 37 may engage with the plunger 36 so that the plunger 36 is biased to move away from the ledge 42 and thus away from the shuttle 35. A portion of the plunger 36 may extend from an upstream most end of the shuttle 36 or otherwise be arranged so that the plunger 36 engages with the port 37 with movement of the shuttle 35 toward the port 37 but before the shuttle 35 reaches a stop or other limit of its travel toward the port 37. Thus, the plunger 36 can engage the port 37 as the shuttle 35 is moved toward the port 37 but has not yet reached the end of its travel. As an example, as the shuttle 35 is moved away from the port 37 from the position shown in FIG. 4, the plunger 36 may remain in contact with the port 37 although the biasing force of the spring 38 on the plunger 36 will be reduced as the shuttle 35 is moved away from the port 37. This permits the plunger 36 to provide a resistance to flow through the port 37 that decreases as the shuttle 35 moves away from the port 37 and increases as the shuttle 35 is moved toward the port 37. Since the shuttle 35 can have an infinite number of positions relative to the valve body 32 between a point at which the plunger 36 first engages the port 37 and a point at which the shuttle 35 reaches a travel limit and can move no further toward the port 37, the plunger 36 can provide an infinite number of different resistances to flow through the port 37.

In some cases, the shuttle 35 may be movable by a user relative to the valve body 32 to adjust the backpressure on fluid in the flowpath or otherwise influence flow through the valve 31. For example, FIG. 6 shows a handle 45 that extends from the shuttle 35 and is configured to permit a user to move the shuttle 35 relative to the valve body 32. An interference fit or friction between the shuttle 35 and the valve body 32 may help hold the shuttle 35 in a position relative to the valve body 32 after being moved to a desired location. In some cases, the shuttle 35 may have one or more defined positions relative to the valve body 32 that can be selected by a user. For example, FIG. 6 shows a slot 46 in the valve body 32 in which the handle 45 moves. The slot 46 can be configured to have one or more notches, e.g., extending perpendicularly to the direction of movement of the shuttle 35 and handle 45, in which the handle 45 can be positioned to put the shuttle 35 at a defined position relative to the body 32. One or more of defined positions of the shuttle 35 may correspond to particular levels of backpressure, crema production, foam production, or other characteristics regarding beverage formation and/or of a finished beverage. For example, the shuttle 35 may have a defined position for dispensing coffee with no foam or crema created, and may have one or more other positions that each correspond to a particular level of crema or foam production and/or a type of coffee beverage. Other arrangements for moving and/or defining a position of the shuttle 35 relative to the body 32 can be employed. For example, the slot 46 can be configured to have a spiral shape so that movement of the handle 45 along the slot 46 rotates the shuttle 35 and moves the shuttle 35 along the flowpath relative to the valve body 32. Thus, the handle 45 may operate as a cam follower and the slot 46 as a cam that interact to move the shuttle 35 to different positions relative to the port 37 as the handle 45 is moved along the slot 46. As another example, the shuttle 35 may be moved by a ball and screw arrangement, e.g., in which a nut attached to the shuttle 35 is engaged with a threaded rod that is fixed relative to the valve body 32. Rotation of the nut relative to the threaded rod can move the shuttle 35 relative to the valve body 32. In some embodiments, the shuttle 35 can be moved by a motor drive arrangement, e.g., a motor may rotate the threaded rod of a ball and screw arrangement like that described above. Of course, other drive arrangements can be employed, including linear motors or other actuators, levers, solenoid actuators (e.g., to slide the shuttle 35 between two or more positions), and so on.

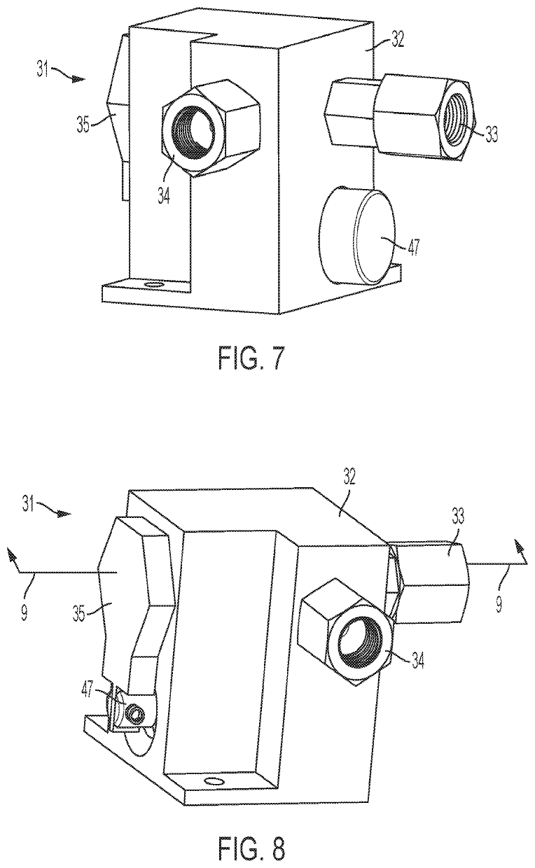

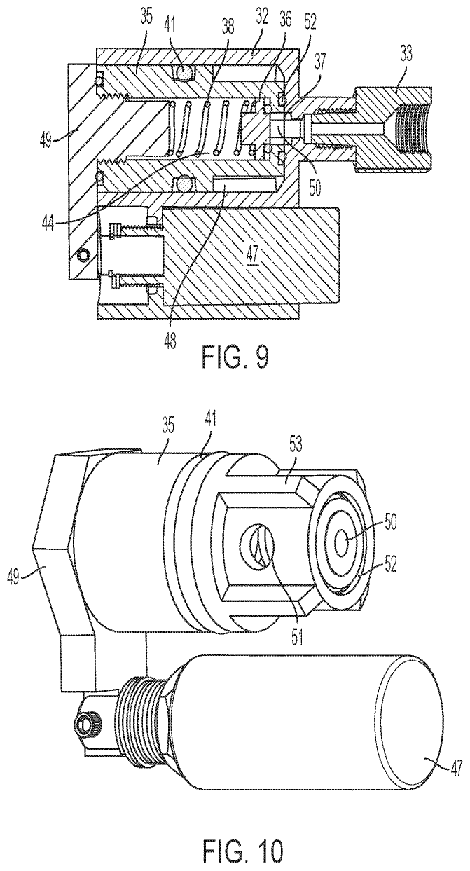

FIGS. 8 and 9 show other embodiments of a valve 31 for use with a beverage machine outlet that incorporates one or more inventive features. In some embodiments, the valve 31 includes a valve body 32, e.g., having a cube-like or box shape, with an inlet 33 for receiving a beverage fluid into the valve 31 and an outlet 34 for outputting a beverage fluid with desired characteristics, such as crema, foam, etc. At least some features described above with respect to the FIGS. 4-6 embodiments are equally applicable to the embodiments of FIGS. 8 and 9, e.g., the inlet 33 can be fluidly coupled to a brew chamber to receive a coffee or other beverage under pressure above ambient, the outlet 34 can output a processed beverage fluid to a user's cup or other dispensing outlet, etc. A shuttle 35 may be movable relative to the valve body 32 in a cavity 48 of the body 32 to adjust a backpressure and/or have other effect on fluid entering the inlet 33, e.g., based on a position of the shuttle 35 relative to the valve body 32. In some cases, an actuator 47 may be employed to move the shuttle 35 relative to the valve body 32. In some embodiments the actuator 47 may include an electromechanical actuator, such as a solenoid, screw drive, linear motor and/or any other suitable device. In some embodiments, the actuator 47 may be powered in any suitable way, e.g., may include a pneumatic, hydraulic or other suitable device, and any suitable actuator 47 may be operated under control of a controller 11. In some embodiments, the shuttle 35 may be moved manually in addition or alternately to an electrically or otherwise powered actuator 47. Manual movement of the shuttle 35 may be effected by a screw drive or other manually operated device, e.g., a user may turn a lead screw that moves relative to the valve body 32 in response to rotation and moves the shuttle 35. In some cases as in FIGS. 7 and 8, the shuttle 35 may be visible outside of the valve body 32, e.g., so that a position of the shuttle 35 and thus its effect on beverage flow through the valve 31 may be observed by a user. An indicator on the shuttle 35 and/or actuator 47 may provide an indication of a level of foam creation, resistance to flow or other effect of the valve 31 on beverage flow. In some embodiments, the shuttle 35 may be entirely housed within the valve body 32 and hidden from view.

As can be seen in FIG. 9, the shuttle 35 is movably disposed in a cavity 48 of the valve body 32, e.g., so the shuttle 35 can move left to right in FIG. 9 or toward and away from the port 37. In some embodiments, the shuttle 35 is sealingly engaged with a wall of the cavity 48, e.g., by an o-ring or other seal 41, that permits the shuttle 35 to maintain sealing engagement for a range of movement of the shuttle 35 in the cavity. In some cases, the sealing engagement between the shuttle 35 and the valve body 32 at the cavity 48 can help prevent the exit of beverage fluid from the cavity 48 except by way of the outlet 34. Although not visible in FIG. 9, the outlet 34 is in fluid communication with the cavity 48. Thus, fluid that enters the cavity 48 from the inlet 33 can flow to the outlet 34. In some cases, the shuttle 35 includes a chamber 44 in which a plunger 36 is positioned and is moveable relative to the shuttle 35. In some cases, the plunger 36 is resiliently biased to move relative to the shuttle 35, e.g., to move towards the port 37 and/or toward an inlet end of the shuttle 35. A spring or other resilient element 38 may be positioned in the chamber 38 or otherwise provided to resiliently bias the plunger 36 in a suitable way. The plunger 36 may be positioned at an inlet end or side of the shuttle 35, and a coupling 49 may be provided at an opposite end of the shuttle 35, e.g., to close the chamber 44 and contact a side of the spring 38 opposite the plunger 36. The coupling 49 may function as a handle 45, e.g., where the shuttle 35 can be manually moved and/or can be connected to the actuator 47 so that movement of the actuator 47 is transmitted to the shuttle 35. The spring 38 may be held in a compressed state in the condition shown in FIG. 9, e.g., so the spring 38 provides a resilient bias on the plunger 36 to move toward the inlet end of the shuttle 35. In some cases, a portion of the coupling 49 may be movable to adjust a compression of the spring 38 and thus a resilient bias of the spring 38 on the plunger 36. This may change a resistance to flow through the shuttle 35. In some cases, the actuator 47 may adjust the biasing force on the plunger 36.

The inlet end of the shuttle 35 may be configured to hold the plunger 36 in the chamber 38, e.g., so the plunger 36 cannot exit the chamber 38 at the inlet end. A wall of the shuttle 35 at the inlet end may include a bore or inlet opening 50 to permit flow into the chamber 44 and may function as a valve seat for a valve formed with the plunger 36. That is, the plunger 36 may function as a valve gate that contacts the wall at the inlet end of the shuttle 35 to close the opening 50 to flow through into the chamber 44 in the absence of suitable pressure at the opening 50. If pressure at the inlet opening 50 is suitably high to move the plunger 36 against the bias of the spring 38, the plunger 36 will move to open the valve seat at the opening 50 to flow so fluid can enter the chamber 44. Thus, the shuttle 35 can include a valve seat against which the plunger 36 is biased to engage to control flow along a path that passes through the valve seat and into the chamber 44. An o-ring or other gasket may be provided on the plunger 36 or otherwise to provide a suitable seal between the plunger 36 and the wall of the shuttle at the inlet end, but is not necessary. As can be seen in FIG. 10, fluid that enters the chamber 44 via the inlet opening 50 can exit the chamber 44 via an outlet opening 51 at a side of the shuttle 35. Fluid that exits the outlet opening 51 enters the cavity 48 and can exit the cavity via the valve outlet 34. The shuttle 35 may include ribs or fins 53 to help provide a gap or space between the shuttle 35 and the walls of the cavity 48 so that fluid in the cavity 48 can flow suitably to the valve outlet 34. The ribs or fins 53 can also provide an alignment function for the shuttle 35, e.g., to help keep the shuttle 35 suitably aligned relative to the valve body 32 for movement in the cavity 48.

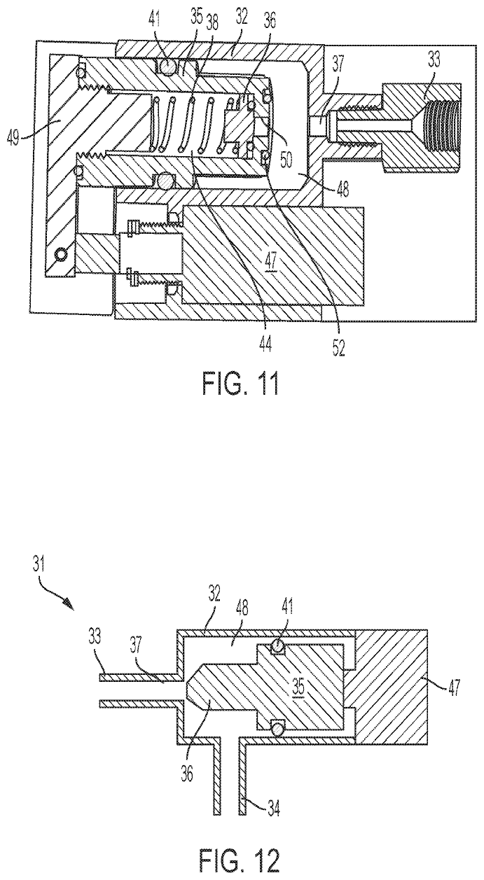

In some cases, the shuttle 35 is movable relative to the valve body 32 between first and second positions in which a resistance to flow along the flowpath from the valve inlet 33 to the valve outlet 34 is higher when the shuttle in the first position than when the shuttle is in the second position. In some embodiments, the shuttle 35 may be movable between a first position in which the shuttle is in contact with and/or in fluid communication with the port 37, and a second position in which the shuttle 35 is out of contact with and/or out of fluid communication with the port 37. For example, FIG. 9 shows an exemplary first position in which the inlet end of the shuttle 35 is in contact with the port 37, e.g., so that flow through the port 37 is forced to flow along a first path into the chamber 44 of the shuttle 35. Flow through the inlet opening 50 may flow past the plunger 36, e.g., around the plunger 36 and to the outlet opening 51 so as to exit the chamber 44 and flow to the cavity 48 and/or valve outlet 34. In some cases, the shuttle 35 may be configured to sealingly engage with a portion of the valve body at the port 37 in the first position, e.g., a gasket 52 at the inlet end of the shuttle 35 may sealingly engage with a portion of the valve body 32 at the port 37 although such sealing engagement is not required. In some cases, the shuttle 35 may simply abut or be closely positioned to the port 37 without sealing engagement, e.g., so the shuttle 35 is in fluid communication with the port 37. This may aid in requiring or otherwise causing flow through the port 37 to enter the chamber 44 via the inlet opening 50. As will be understood, the bias of the spring 38 on the plunger 36 may provide resistance to flow through the inlet opening 50, thereby increasing a backpressure in the flowpath upstream of the port 37. As can be seen in FIG. 11, the shuttle 35 may be moved to a second position in which flow through the port 37 is along a second path that bypasses the chamber 44 or other portions of the shuttle 35 and instead flows into the cavity 48 and to the valve outlet 34. This second path may have a reduced resistance to flow as compared to the first path through the chamber 44 of the shuttle 35. In some cases, the shuttle 35 may be positioned at one or more locations between the first and second positions shown in FIGS. 9 and 11, and thereby provide different resistances to flow from the inlet 33 to the outlet 34 of the valve 31. For example, the shuttle 35 may be positioned so that flow through the port 37 passes both into the cavity 48 and into the chamber 44 via the inlet opening 50, e.g., by positioning the shuttle 35 so that a suitable resistance to flow from the port 37 into the cavity 48 causes a pressure in areas near the inlet opening 50 so that the plunger 36 is moved to permit flow into the chamber 44. In such a case, a resistance to flow may be between a relatively high resistance provided for the first position and a relatively low resistance for the second position. As will be understood, an infinite number of resistances may be provided for the infinite possible positions of the shuttle 35 relative to the valve body 32. In some cases, the shuttle 35 may be configured to provide only two resistances to flow, e.g., where the actuator 47 is a solenoid capable of positioning the shuttle 35 in only two stationary positions relative to the valve body 32.

FIG. 12 shows a valve 31 arrangement that can be configured to operate to provide two resistances to flow, or multiple resistances to flow. In some embodiments, the valve 31 can include a valve body 32 with a cavity 48 and an inlet 33 and outlet 34 to the cavity 48. A shuttle 35 can be positioned in the cavity 48 and movable relative to the valve body 32 and/or the port 37 to influence flow through the port 37. An o-ring or other seal 41 may be provided so the shuttle 35 sealingly engages with a wall of the cavity 48 through a range of movement, e.g., so fluid in the cavity 48 does not flow past the shuttle 35 to exit the cavity 48. An actuator 47 such as a solenoid may be configured to move the shuttle 35 in the cavity 48. In some cases, the actuator 47 may be capable of moving the shuttle 35 between only two positions relative to the valve body 32, e.g., between relatively high and low resistance to flow from the inlet 33 to the outlet 34. In some embodiments, the shuttle 35 can include a plunger 36 or other valve gate that is movable relative to the port 37 to provide resistance, or not, to flow through the port 37. For example, the shuttle 35 may be moveable to a first position so the plunger 36 contacts the port 37 to resist flow through the port 37 and into the cavity 48, and a second position in which the plunger 36 provides little or no resistance to flow through the port 37. Such an arrangement may employ a two-position solenoid that is capable of moving between only two positions, i.e., first and second positions for the shuttle 35. As described above, the plunger 36 may be coupled to the shuttle 35 by a resilient element such as a spring so the plunger 36 is resiliently biased toward the port 37 or other valve seat, e.g., as in a typical check valve. However, in some cases the plunger 36 may be fixed relative to the shuttle 35, e.g., where an actuator or other portion of the valve includes a resilient element. The plunger 36 may include a resilient valve gate or other portion that contacts the port 37 or other valve seat, e.g., so as to provide a check valve feature when the shuttle 35 is moved so the plunger 36 contacts the port 37 or other valve seat. In some cases, the plunger 36 may include one or more flow channels to provide a desired resistance to flow when the shuttle 35 is moved to provide a relatively high resistance to flow, e.g., with the plunger 36 in contact with the port 37, flow through the port 37 may be required to flow at least in part through one or more flow channels of the plunger 36 so as to provide a desired resistance to flow. In some cases, the actuator 47 may include a spring that biases the shuttle 35 so the plunger 36 normally contacts the port 37 or other valve seat, e.g., so the valve 31 operates as a simple check valve. Suitably high-pressure flow through the port 37 may cause the shuttle 35 to move against the actuator spring to permit flow into the cavity 48. To provide a relatively lower resistance to flow in such a typical check valve configuration, a three-way valve or other arrangement may be provided upstream of the inlet 33 so flow can be permitted to bypass the valve 31 entirely and flow directly to the outlet 34.

In some cases, the valve 31 may provide three or more resistances to flow from the inlet 33 to the outlet 34. In some embodiments, the actuator 47 may include a solenoid, linear motor or other device that can move the shuttle 35 and provide a variable force on the shuttle 35. For example, the shuttle 35 and plunger 36 may be configured to move so the plunger 36 can contact the port 37 or other valve seat to resist flow through the port 37 and into the cavity 48. The actuator 47 may be configured to exert a force on the shuttle 35 so the plunger 36 engages with the port 37 or other valve seat with two or more contact forces so as to provide two or more resistances to flow through the port 37. Where the actuator 47 is configured to provide an infinitely variable force on the shuttle 35, the valve 31 can provide an infinite number of resistances to flow through the port 37. The actuator 47 may also be configured to move the shuttle 35 so the plunger 36 is entirely out of contact with the port 37 to provide a relatively low resistance to flow.

Movement of the shuttle 35 of an outlet valve 31 and/or operation of other components of the machine 100 may be controlled by the control circuit 11, which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface on the housing 10), communication buses or other links, a display, switches, relays, triacs, or other components necessary to perform desired input/output or other functions. A user interface may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on. Liquid may be introduced into the brew chamber 15 at any suitable pressure, e.g., 1-2 psi or higher, and the pressure may be adjustable by the control circuit 11, e.g., based on operation of the pump 12 and/or outlet valve 31. While in this illustrative embodiment, a liquid supply system arranged to provide liquid to a beverage outlet (at the brew chamber 15) may include a pump 12, other arrangements may be used, such as gravity flow of liquid, flow forced by air pressure, or other motive force.

For those systems employing a cartridge 1, the beverage forming system 100 may access or otherwise use the cartridge 1 in any suitable way. For example, one or more inlet needles associated with the cover 4 or other part of the system 100 may pierce the cartridge 1 (e.g., a lid of the cartridge) so as to inject heated water or other liquid into the cartridge 1. The injected liquid may form the desired beverage or a beverage precursor by mixing with beverage material in the cartridge 1. The cover 4, cartridge holder 3 or other portion of the system 100 may also include one or more outlet needles or other elements to puncture or pierce the cartridge 1 at an outlet side to permit the formed beverage to exit the cartridge 1. Other inlet/outlet piercing arrangements are possible, such as multiple needles, a shower head, a non-hollow needle, a cone, a pyramid, a knife, a blade, etc. In another arrangement, a beverage machine may include a piercing element (such as a spike) that forms an opening and thereafter a second inlet element (such as a tube) may pass through the formed hole to introduce liquid into (or conduct liquid out of) the container. As with the inlet piercing arrangement, the outlet piercing arrangement may be varied in any suitable way. Thus, the outlet piercing element may include one or more hollow or solid needles, knives, blades, tubes, and so on.

Alternately, the cartridge 1 may include a valve, septum or other element that opens to permit beverage to exit when liquid is introduced into the cartridge, but otherwise remains closed (e.g., to protect the beverage medium from external conditions such as oxygen, moisture or others). In such a case, no piercing element for forming the outlet opening is necessarily required although may be used, e.g., to allow the valve or other element to open. Also, in some embodiments the piercing element remains in place to receive beverage as it exits the opening formed in the cartridge. However, in some embodiments, the piercing element may withdraw after forming an opening, allowing beverage to exit the opening and be received without the piercing element being extended into the cartridge 1. Other arrangements for a beverage outlet are possible however, e.g., the cartridge may have a permeable portion that allows beverage to exit cartridge 1. Also, there is no requirement that an inlet and/or an outlet pierce a cartridge to provide liquid to, or receive beverage from, a cartridge. Instead, communication with a cartridge may be performed using any suitable ports or other features. Regardless of how beverage is output from a cartridge, the beverage outlet may be fluidly coupled to an outlet valve 31, e.g., so the valve 31 can influence a pressure in the cartridge or otherwise control characteristics of beverage dispensed.

With a beverage material provided in the brew chamber 15, the control circuit 11 may operate in different ways to dispense a beverage. In some embodiments, the control circuit 11 may automatically select one or more brew parameters for automatically controlling the liquid supply to dispense a beverage during a dispensing operation. For example, the control circuit 11 may select default values for parameters such as a beverage volume, beverage temperature, whether beverage frothing or whipping will be employed, a beverage dispense time or speed, a precursor liquid flow rate, a precursor liquid pressure, whether beverage chilling will be employed, whether brew chamber air or steam purge will be employed, whether beverage material pre-wet or pulse-type brewing will be employed and if so time periods between liquid delivery, a backpressure provided by the output valve 31, and others. Such parameters may be automatically determined in different ways, such as by reading parameter values from an information element (such as an RFID tag) on a cartridge 1, receiving input from a user via a user interface such as by the user pressing a button or otherwise indicating a parameter, by employing default values stored in a memory of the control circuit 11, and/or by a combination of such techniques or others. In some cases, the control circuit 11 may begin a dispensing operation once the brew parameter values are set, or in response to additional user input such as the user pressing a brew start button. In one example, a user may press one of several beverage volume buttons to select a beverage volume, and then press a brew start button to cause the control circuit 11 to start an automated dispensing operation. Parameters used to dispense a beverage may be set by default by the control circuit 11 and/or by input from the user. For example, other brew parameters such as beverage temperature, etc. may be automatically selected by the control circuit 11 using default values unless the user provides additional input to adjust those values.

With water or other liquid sufficiently heated in the heater tank, the control circuit 11 may continue with the automated process of beverage dispensing by causing the pump 12 to deliver liquid to the tank, thereby delivering heated liquid to the brew chamber 15. The control circuit 11 may sense or otherwise keep track of a volume of liquid delivered to the brew chamber 15 so that the appropriate beverage volume can be dispensed. For example, the control circuit 11 may cause the pump 12 to operate a specified number of cycles where a particular volume of liquid is delivered by the pump 12 for each pump cycle. Alternately, a flow meter may be used by the control circuit 11 to detect a volume of liquid delivered to the brew chamber 15, or other techniques.

Pressure in the brew chamber 15 may be sensed, e.g., using a sensor in the brew chamber 15 or line coupled to the chamber 15, and the control circuit 11 may adjust the outlet valve 31 or other parameters to control a backpressure in the brew chamber 15. Thus, varying levels of backpressure may be employed in the formation of a single beverage, or a single backpressure level may be used.

While aspects of the invention may be used with any suitable cartridge, or no cartridge at all, some cartridges may include features that enhance the operation of a beverage forming system 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed.

In some embodiments, a cartridge may be provided in the form of a beverage tablet. In some embodiments, the beverage ingredients of the beverage tablet have been compacted to form the tablet. The beverage tablet may be able to hold its own shape, and thus may not require individual packaging to prevent dispersing of the beverage ingredients prior to use in forming a beverage. In some embodiments, the tablet may be coated. In some embodiments, the beverage tablet may directly contact a beverage machine without intervening packaging containing the beverage tablet. For example, in some embodiments, the coating of the beverage tablet, or the compacted ingredients (e.g. coffee grounds) of the tablet, may directly contact a beverage machine without intervening packaging.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A valve for use with a beverage machine outlet, comprising:
a valve body having a cavity, an inlet, an outlet, a port between the inlet and the cavity, and a flowpath from the inlet to the outlet including the port and at least a portion of the cavity; and
a shuttle movable relative to the valve body in the cavity and including a plunger that is movable relative to the shuttle and resiliently biased to move toward the port, the shuttle being configured to adjust a backpressure on fluid in the flowpath based on a position of the shuttle relative to the port.

2. The valve of claim 1, wherein the shuttle is movable between a first position in which the shuttle is in contact with the port, and a second position in which the shuttle is out of contact with the port.

3. The valve of claim 2, wherein the plunger is configured to contact the port to resist flow through the port.

4. The valve of claim 2, wherein the shuttle is in fluid communication with the port in the first position and is out of fluid communication with the port in the second position.

5. The valve of claim 1, wherein the shuttle is movable between a first position in which flow through the port flows along a first path into a chamber of the shuttle and past the plunger, and a second position in which flow through the port is along a second path that bypasses the chamber.

6. The valve of claim 5, wherein the shuttle includes a valve seat against which the plunger is biased to engage and flow along the first path passes through the valve seat and into the chamber.

7. The valve of claim 6, further comprising a spring between the shuttle and the plunger configured to resiliently bias the plunger toward the valve seat.

8. The valve of claim 5, wherein a resistance to flow along the flowpath is higher with the shuttle in the first position than a resistance to flow along the flowpath with the shuttle in the second position.

9. The valve of claim 1, further comprising a spring between the shuttle and the plunger configured to resiliently bias the plunger toward the port.

10. The valve of claim 1, wherein the shuttle includes a chamber having a shuttle inlet at an inlet end and a shuttle outlet, the plunger being positioned at the inlet end of the shuttle.

11. The valve of claim 10, wherein the plunger is movable in the chamber.

12. The valve of claim 11, further comprising a spring positioned in the chamber and configured to resiliently bias the plunger toward the inlet end of the chamber.

13. The valve of claim 10, wherein the shuttle includes a valve seat that defines the shuttle inlet and the plunger is biased to move into contact with the valve seat.

14. The valve of claim 13, wherein the shuttle is movable in the cavity between a first position in which flow through the port passes through the chamber to the outlet, and a second position in which flow through the port bypasses the chamber and passes through the cavity to the outlet.

15. The valve of claim 10, wherein the shuttle is movable in the cavity between a first position in which flow through the port passes through the chamber to the outlet and a second position in which flow through the port bypasses the chamber and enters the cavity.

16. The valve of claim 1, wherein the shuttle includes a chamber in which the plunger is positioned and the chamber and the plunger are configured to permit fluid flow past the plunger and through the chamber.

17. The valve of claim 1, wherein the shuttle is sealingly engaged with the valve body in the cavity.

18. The valve of claim 1, wherein the shuttle is movable by a user relative to the valve body to adjust the backpressure on fluid in the flowpath.

19. The valve of claim 1, wherein the cavity, shuttle and port are configured to adjust an amount of crema or foam produced by the valve in coffee flowing through the valve based on a position of the shuttle relative to the port.

20. The valve of claim 1, in combination with a beverage machine comprising:
a liquid supply arranged to provide a liquid for forming a beverage; and
a brew chamber arranged to mix the liquid with a beverage material to form a beverage,
wherein the valve is fluidly coupled to an outlet of the brew chamber and is configured to adjust a pressure in the brew chamber based on the position of the shuttle relative to the port.

21. A valve for use with a beverage machine outlet, comprising:
a valve body having an inlet, an outlet, a cavity, a port and a flowpath from the inlet to the outlet that includes at least a portion of the cavity and the port, the cavity being downstream of the port and having larger cross-sectional area than the port; and
a shuttle movable in the cavity relative to the port and including a plunger that is resiliently biased to move relative to the shuttle, the shuttle being configured to adjust a backpressure on fluid in the flowpath based on a position of the shuttle relative to the port.

22. The valve of claim 21, further comprising a spring between the shuttle and the plunger configured to resiliently bias the plunger toward the port.

23. The valve of claim 21, wherein the shuttle includes a chamber having a shuttle inlet at an inlet end and a shuttle outlet, the plunger being movable in the chamber and positioned at the inlet end of the shuttle.

24. The valve of claim 23, wherein the shuttle includes a valve seat that defines the shuttle inlet and the plunger is resiliently biased to move into contact with the valve seat.

25. The valve of claim 24, wherein the shuttle is movable in the cavity between a first position in which flow through the port passes through the chamber to the outlet and a second position in which flow through the port bypasses the chamber and passes through the cavity to the outlet.

26. The valve of claim 25, wherein the shuttle is configured to sealingly engage with a portion of the valve body at the port in the first position.

27. The valve of claim 25, wherein a resistance to flow along the flowpath with the shuttle in the first position is higher than a resistance to flow along the flowpath with the shuttle in the second position.

28. The valve of claim 21, wherein the shuttle is movable by a user relative to the valve body to adjust the backpressure on fluid in the flowpath.
